(19) United States
(12) Patent Application Publication
(10) Pub. No.: US 2011/0069082 A1
(43) Pub. Date: Mar. 24, 2011

(54) IMAGE CONTROL APPARATUS, INFORMATION PROCESSING APPARATUS, IMAGE CONTROL METHOD, AND RECORDING MEDIUM

(75) Inventor: Nobutaka ISHIDERA, Kawasaki (JP)

(73) Assignee: FUJITSU LIMITED, Kawasaki-shi (JP)

(21) Appl. No.: 12/884,529

(22) Filed: Sep. 17, 2010

(30) Foreign Application Priority Data
Sep. 18, 2009 (JP) 2009-216961
Jun. 24, 2010 (JP) 2010-143314

(51) Int. Cl. G09G 5/02

(52) U.S. Cl. 345/593

(57) ABSTRACT

An image control apparatus including a color information acquisition unit configured to acquire, from a memory, color information expressing a power saving color, a display image acquisition unit configured to acquire a display image displayed on a display device, a compensation unit configured to compensate the display image acquired by the display image acquisition unit, based on the acquired color information, and a display unit configured to cause the display device to display the compensated display image.

### CROSS-REFERENCE TO RELATED APPLICATIONS

This application is based upon and claims the benefit of priority of the prior Japanese Patent Application No. 2009-216961, filed on Sep. 18, 2009, and No. 2010-143314, filed on Jun. 24, 2010, the entire contents of which are incorporated herein by reference.

### FIELD

Embodiments discussed herein relate to an image control apparatus, information processing apparatus, and image control method.

### BACKGROUND

In display devices such as liquid crystal displays (LCDs) and organic electro-luminescence (EL) displays, there exists a display color for which the power consumption is considered minimized. The particular display color primarily depends on whether or not voltage is added to the display pixels. For example, there exist LCDs that display screens by applying voltages to the display pixels and lowering the brightness of particular dots. When voltage is not applied to the display pixels in such LCDs, light from a backlight disposed behind the display pixels is transmitted through the display pixels. For this reason, power consumption is decreased as the displayed image becomes increasingly white. In other words, less power is consumed with a whiter display color.

By way of example, consider an LCD configured as above and having a resolution of 1024×600. When a typical color image is displayed with such an LCD, the power consumption varies between about 862 mW and about 947 mW. The exact power consumption varies depending on the image being displayed. When the entire display screen area displays black, the power consumption becomes about 947 mW. When the entire display screen area displays white, the power consumption becomes about 862 mW. Hereinafter, the terms “power saving color” will be used to refer to the display color that, depending on the display method, causes the power consumption of the display device to be minimized when that color is displayed.

### SUMMARY

According to an aspect of the invention, an image control apparatus including a color information acquisition unit configured to acquire, from a memory, color information expressing a power saving color, a display image acquisition unit configured to acquire a display image displayed on a display device, a compensation unit configured to compensate the display image acquired by the display image acquisition unit, based on the acquired color information, and a display unit configured to cause the display device to display the compensated display image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the hardware configuration of an image control apparatus in accordance with the present embodiment;

FIG. 2 illustrates the configuration of a display;

FIG. 3 illustrates display information conforming to SMBIOS;

FIG. 4 illustrates display information as a file;

FIG. 5 illustrates display information that has been read into main memory;

FIG. 6 illustrates settings information;

FIG. 7 illustrates the functional configuration of an image control apparatus in accordance with the present embodiment;

FIG. 8 is a flowchart illustrating the operation of an image control apparatus in accordance with the present embodiment;

FIG. 9 is a flowchart illustrating a wallpaper compensation process;

FIG. 10 is a flowchart illustrating a screen compensation process;

FIG. 11 illustrates a display screen and its compensated image;

FIG. 12 is a flowchart illustrating a specified region compensation process;

FIG. 13 is a flowchart illustrating a special user operation process;

FIG. 14 is a flowchart illustrating an update process;

FIG. 15 illustrates an update conducted by the update process;

FIG. 16A illustrates an example of information displayed on a display screen;

FIG. 16B is an enlarged view of a displayed character;

FIG. 17 illustrates an example of RGB data written to the video RAM of a graphics controller;

FIG. 18 is a diagram for explaining the colors expressed by RGB data written to the video RAM of a graphics controller;

FIG. 19 is a flowchart illustrating a process for computing the average value between the color of an image pixel and the power saving color;

FIG. 20 illustrates an example of RGB data written to video RAM after being compensated.

### DESCRIPTION OF EMBODIMENTS

Hereinafter, embodiments of the present invention will be described with reference to the accompanying drawings.

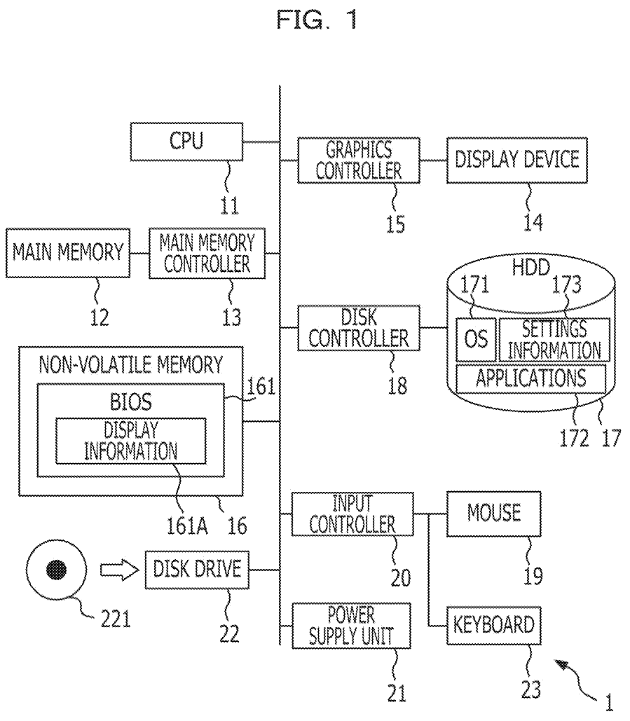

First, the hardware configuration of an image control apparatus in accordance with the present embodiment will be described. FIG. 1 illustrates an example hardware configuration of an image control apparatus in accordance with the present embodiment.

As illustrated in FIG. 1, the image control apparatus 1 includes a central processing unit (CPU) 11, a main memory 12, a main memory controller 13, a display device 14, a graphics controller 15, a non-volatile memory 16, a hard disk drive (HDD) 17, a disk controller 18, a mouse 19, an input controller 20, a power supply unit 21, a disk drive 22, and a keyboard 23. The CPU 11 controls the overall operation of the image control apparatus 1. The main memory 12 stores data to be processed by the CPU 11. The main memory controller 13 controls the main memory 12. The graphics controller 15 houses video RAM, for example. Following instructions from the CPU 11, the graphics controller 15 writes RGB data to the video RAM. The RGB data expresses information to be displayed on the display device 14. The graphics controller 15 controls what is displayed on the display device 14, on the basis of the RGB data written to the video RAM. The disk controller 18 controls the HDD 17. The input controller 20 accepts user operations input with the mouse 19 and the keyboard 23, and notifies the CPU 11 of such operations. In addition, the input controller 20 may also accept user operations input with other input devices, such as a trackball, for example.

The power supply unit 21 supplies power to each device in the image control apparatus 1. In addition, the power supply unit 21 may also supply power to the display device 14 separately from the other devices via a power controller circuit.

The disk drive 22 reads out data stored on a recording medium, such as the disk 221. In the present embodiment, the HDD 17 stores an operating system (OS) 171, applications 172 that run on the OS 171, and settings information 173 to be hereinafter described. The OS 171 accepts user operations input with the mouse 19, and presents a graphical user interface (GUI) to the user. The GUI is output to the display device 14 as a display screen showing display information. The non-volatile memory 16 stores a basic input/output system (BIOS) 161, which includes display information 161A to be hereinafter described.

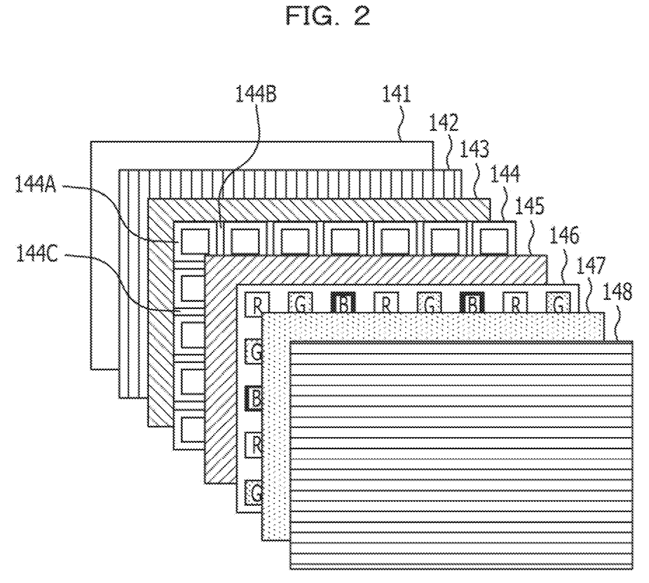

The configuration of the display device 14 will now be described. FIG. 2 illustrates an example of the configuration of a display.

The display device 14 in the present embodiment is a transmissive LCD. The display device 14 includes a backlight 141, a vertical polarizing filter 142, a glass substrate 143, an array substrate 144, a liquid crystal layer 145, a color filter 146, a glass substrate 147, and a horizontal polarizing filter 148. The backlight 141 is the white light source in the example display device 14. In the array substrate 144, there is a plurality of display pixels 144A arranged in a two-dimensional array, and a voltage is applied to a target display pixel 144A by a vertical Y electrode 144B and a horizontal X electrode 144C. The display device 14 in accordance with the present embodiment uses a normally white (NW). Consequently, by applying a voltage to a display pixel 144A, white light from the backlight 141 is blocked at a corresponding location in the liquid crystal layer 145. The display device 14 displays white when no voltage is applied to the array substrate 144, and displays black when a voltage is applied. Given this configuration, the display device 14 in accordance with the present embodiment consumes the least amount of power while displaying white.

It should be appreciated that the display device 14 herein may also be an LCD that uses a normally black (NB). Furthermore, the display device 14 is not limited to being an LCD, and may be any display device that controls what is displayed. For example, the display device 14 may be any display device that controls what is displayed by applying voltages to display pixels. An organic EL display device is one example of such a display device. An organic EL display device displays images by applying voltages to display pixels and thereby causing organic material to emit light. For this reason, power consumption is lowest when the organic EL display device is in a non-emitting state. Given this configuration, a typical organic EL display consumes the least power while displaying black.

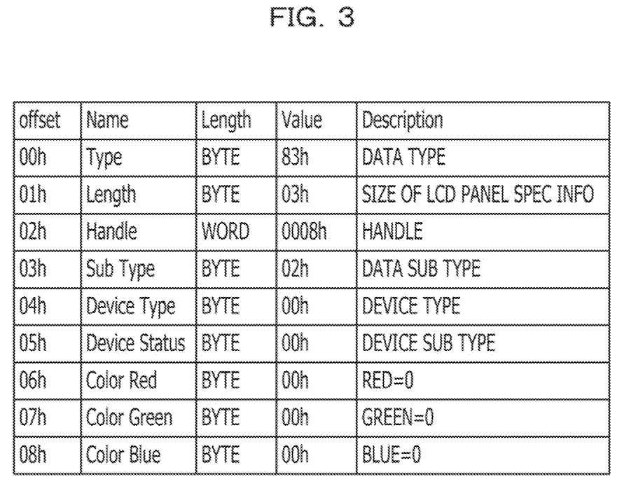

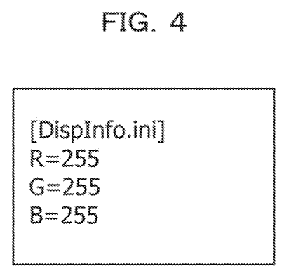

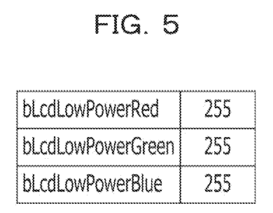

An example of display information and settings information will now be described. FIG. 3 illustrates display information conforming to SMBIOS. FIG. 4 illustrates display information as a file. FIG. 5 illustrates display information that has been read into main memory.

The display information 161A at least includes information regarding the power saving color of the display device 14. As illustrated in FIG. 3, the display information (e.g., color information) 161A in the present embodiment is stored in the non-volatile memory 16 on the basis of a format conforming to SMBIOS. The display information 161A includes multiple types of information regarding the display, which are respectively associated with Offset, Name, Length, Value, and Description fields, for example. The Offset field expresses the relative position of the associated information in the display information. The Name field expresses the type of the associated information. The Length field expresses the length of the associated information. The Value field expresses the value of the associated information. The Description field expresses a description of the associated information. In the display information 161A, the power saving color is expressed using RGB. In FIG. 3, since all RGB values are 0, the power saving color is black. The display information 161A herein may also be a file wherein the power saving color is specified, as illustrated in FIG. 4. In this case, the display information 161A may be stored in a memory region that is accessible by the image control apparatus 1. Examples of such memory regions include the HDD 17, or a memory medium on a network to which the image control apparatus 1 can connect. Whichever format is used, in the process to be hereinafter described, the display information 161A is stored in the main memory 12 in a format like that illustrated in FIG. 5, for example.

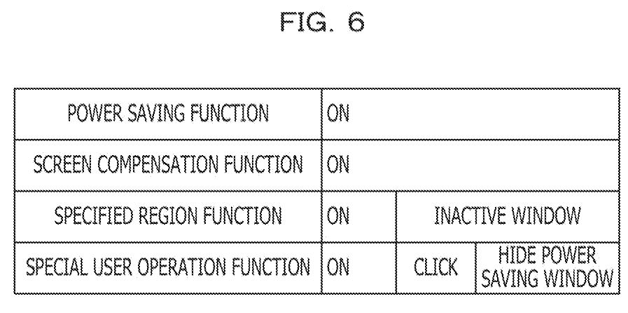

Settings information will now be described. FIG. 6 illustrates settings information. The settings information 173 expresses settings regarding multiple functions in accordance with the present embodiment. More specifically, as illustrated in FIG. 6, the settings information 173 expresses the following: whether or not a power saving function is active; whether or not a screen compensation function is active; whether or not a specified region function is active; and whether or not a special user operation function is active. The above functions are expressed as being active or inactive by ON or OFF, respectively. In addition, the settings information 173 also expresses the following additional information: the target region for the specified region function (i.e., the specified region) for when the specified region function is ON; and both the operation and operation target for when the special user operation function is ON.

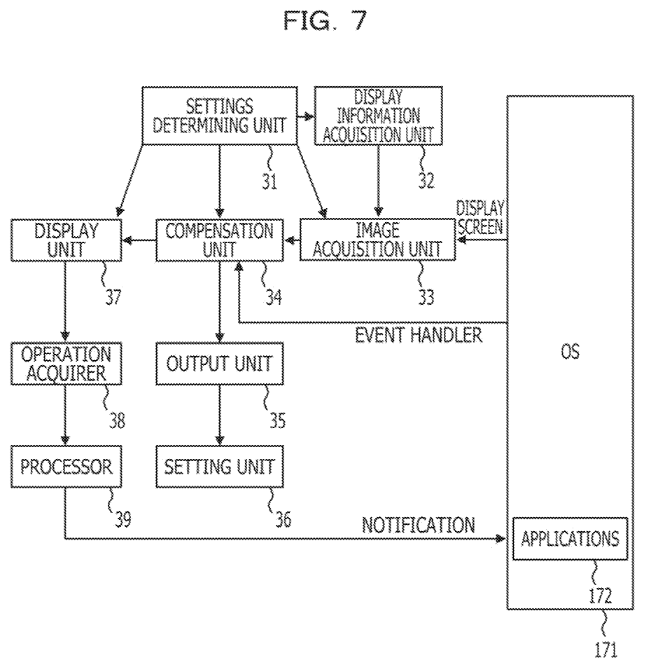

The functional configuration of the image control apparatus in accordance with the present embodiment will now be described. FIG. 7 illustrates the functional configuration of an image control apparatus in accordance with the present embodiment.

As illustrated in FIG. 7, the image control apparatus 1 includes the following as functions: a settings determining unit 31, a display information acquisition unit (color information acquisition unit) 32, an image acquisition unit (displayed image acquisition unit) 33, a compensation unit 34, an output unit 35, a setting unit (display unit) 36, a display unit 37, an operation acquirer 38, and a processor 39. These functions are realized by the CPU 11 and the main memory 12 working in conjunction with each other. The settings determining unit 31 acquires the settings information 173 stored in the HDD 17, and determines whether or not the individual functions described earlier are active. The display information acquisition unit 32 acquires the display information from the non-volatile memory 16. The image acquisition unit 33 acquires the wallpaper image (displayed image) set for the desktop in the GUI or the display screen image (displayed image) displayed on the display device 14, for example. Herein, the wallpaper image is an image that has been selected by the user. The compensation unit 34 compensates the wallpaper image or the display screen image acquired by the image acquisition unit 33, while also acquiring the event handler of the OS 171. The output unit 35 takes the compensated wallpaper image that was compensated by the compensation unit 34, and outputs to the HDD 17. The setting unit 36 sets the wallpaper image that was output to the HDD 17 as the desktop. The display unit 37 causes the display screen image that was compensated by the compensation unit 34 to be displayed on the display device 14 via the graphics controller 15 and a display driver not illustrated in the drawings. The operation acquisition unit 38 acquires user input made with the mouse 19 with respect to the display screen image displayed by the display unit 37. The processor 39 notifies the OS 171 of user input acquired by the operation acquisition unit 38.

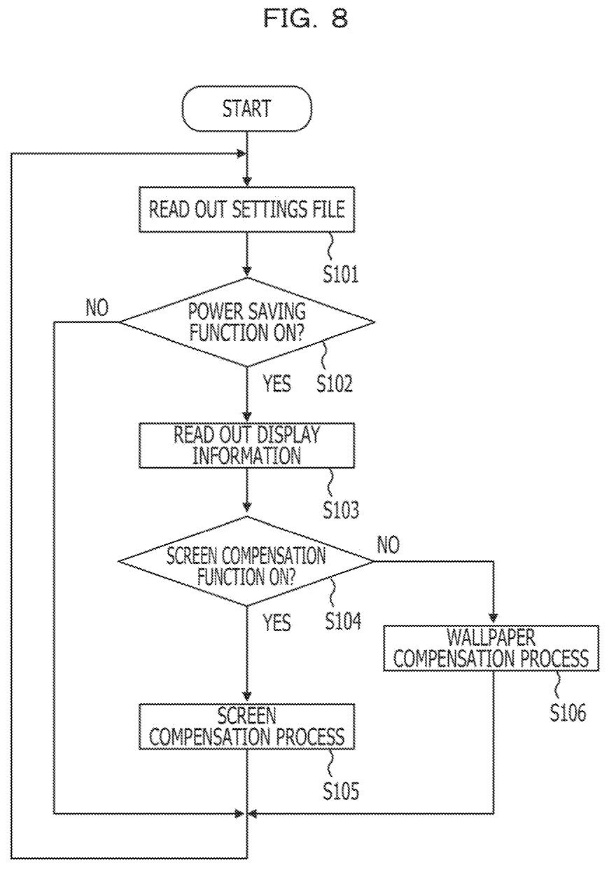

The operation of the image control apparatus will now be described. FIG. 8 is a flowchart illustrating an example operation of an image control apparatus in accordance with the present embodiment.

As illustrated in FIG. 8, first the settings determining unit 31 reads out the settings information 173 from the HDD 17, and stores the settings information 173 in the main memory 12 (S101). The settings determining unit 31 then determines whether or not the power saving function is ON (S102).

If the power saving function is ON (S102, YES), then the display information acquisition unit 32 reads out the information expressing the power saving color in the display information 161A from the non-volatile memory 16, and stores the retrieved information in memory (S103). Subsequently, the settings determining unit 31 determines whether or not the screen compensation function is ON (S104).

If the screen compensation function is ON (S104, YES), then the image control apparatus 1 executes a screen compensation process to be hereinafter described (S105).

In contrast, if the screen compensation function is OFF (S104, NO), then the image control apparatus 1 executes a wallpaper compensation process (S106).

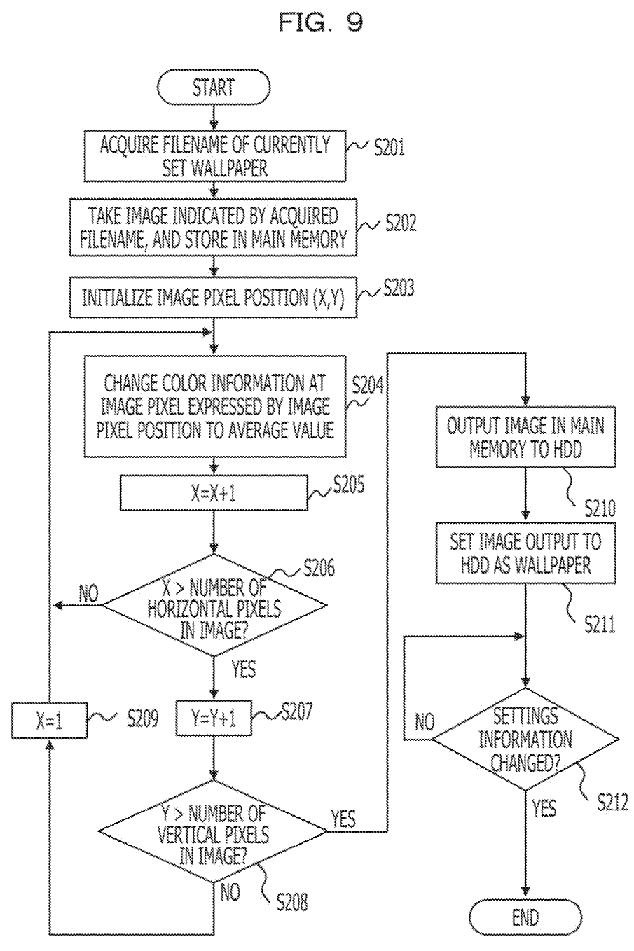

The wallpaper compensation process will now be described. FIG. 9 is a flowchart illustrating a wallpaper compensation process.

As illustrated in FIG. 9, first the image acquisition unit 33 acquires the filename of the wallpaper set as the desktop (S201), reads out the image indicated by the acquired filename, and stores the retrieved image in the main memory 12 (S202). Next, the compensation unit 34 initializes the target image pixel position (X,Y) where image processing is to be conducted with respect to the image stored in the main memory 12 (S203). Herein, X is a variable expressing the horizontal position, and Y is a variable expressing the vertical position. These variables are both set to 1.

Next, the compensation unit 34 computes the average value between the color value of the image pixel expressed by the image pixel position, and the power saving color. The compensation unit 34 then changes the color value at the image pixel position to the computed average value (S204). After changing the value, the compensation unit 34 increments X by 1 (S205), and determines whether or not the value of X is greater than the number of image pixels in the horizontal direction of the image (S206). Herein, the process for computing the average value between the color value of the image pixel and the power saving color will be described later.

If the value of X is greater than the number of image pixels in the horizontal direction of the image (S206, YES), then the compensation unit 34 increments Y by 1 (S207), and determines whether or not the value of the Y is greater than the number of image pixels in the vertical direction of the image (S208).

If the value of Y is less than or equal to the number of image pixels in the vertical direction of the image (S208, NO), then the compensation unit 34 substitutes 1 for the value of X (S209). The compensation unit 34 computes the average value between the color value of the image pixel expressed by the image pixel position, and the power saving color. The compensation unit 34 then changes the color value at the image pixel position to the computed average value (S204).

Meanwhile, if it is determined in step S206 that the value of X is less than or equal to the number of image pixels in the horizontal direction of the image (S206, NO), then the compensation unit 34 computes the average value between the color value of the image pixel expressed by the image pixel position and the power saving color. The compensation unit 34 then changes the color value at the image pixel position to the computed average value (S204).

Meanwhile, if it is determined in step S208 that the value of Y is greater than the number of image pixels in the vertical direction of the image (S208, YES), then the output unit 35 outputs the image in the main memory 12 to the HDD 17 (S210). At this point, the colors in the image have been changed by the compensation unit 34. Next, the setting unit 36 sets the image output to the HDD 17 by the output unit 35 as a wallpaper (S211). This wallpaper is used as a background image for the graphical user interface provided by the OS 171. After setting the wallpaper, the settings determining unit 31 determines whether or not the settings information has changed (S212).

If the settings information has changed (S212, YES), then the settings determining unit 31 terminates the wallpaper setting process. In contrast, if the settings information has not changed (S212, NO), then the settings determining unit 31 once again determines whether or not the settings information has changed (S212).

In this way, the wallpaper that has been set is compensated on the basis of the power saving color. In so doing, power saving effects for the display device 14 may be obtained without using a power saving wallpaper. Stated differently, the user's desired and/or preferred wallpaper may be set as the desktop while still obtaining power saving effects for the display device 14.

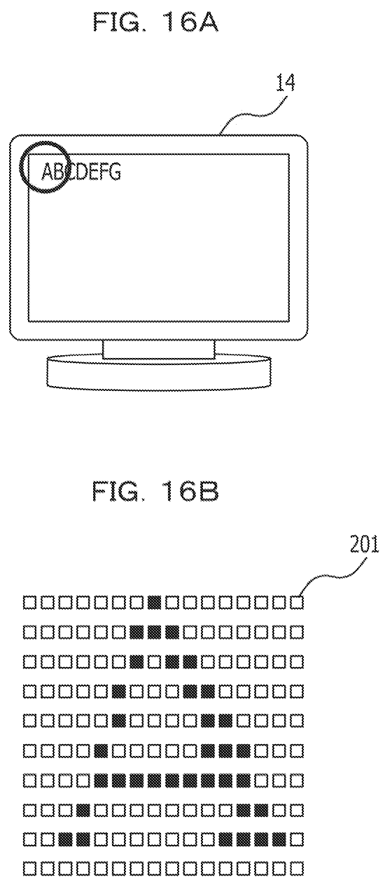

The process for computing an average value in step S204 described above will now be described with reference to FIGS. 16 to 20.

Text and images displayed on the screen of the display device 14 are made up of collections of color-emitting pixels (e.g.,, dots). The particular colors emitted by individual pixels depend on the trichromatic (red (R), green (G), and blue (B)) values expressed by RGB data arrayed in the video RAM 15A. FIG. 16A illustrates a display device 14 wherein the text string “ABCDEFG” is being displayed on-screen. FIG. 16B is an enlarged view of a portion of the screen in FIG. 16A. As illustrated in FIG. 16, the letter “A” is made up of a collection of pixels 201, which emit either black or white.

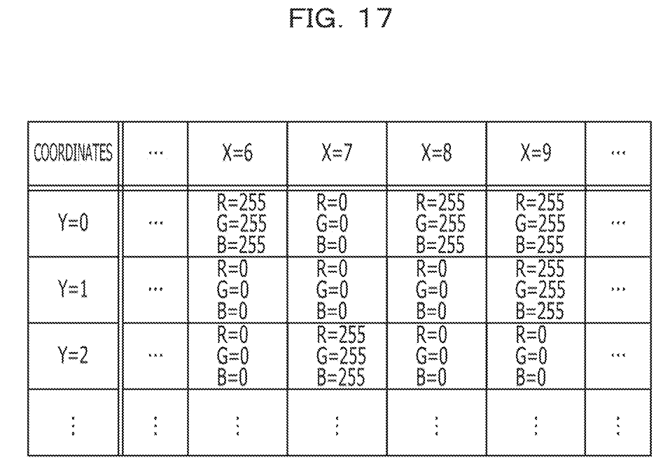

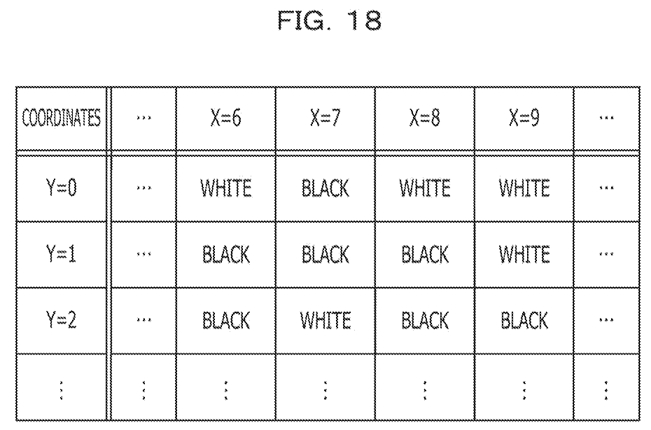

One example of RGB data arrayed in the video RAM 15A is illustrated in FIG. 17. Individual pixels are specified with XY coordinates. In practice, values corresponding to R, G, and B are written as byte values for each pixel. The respective R, G, and B values each take a value between 0 and 255. A value of 0 indicates a non-emitting state, while a value of 255 indicates the state of brightest emission. For example, black becomes R=0, G=0, B=0, while white becomes R=255, G=255, B=255. Consequently, the colors of the pixels expressed by the RGB data arrayed in FIG. 17 express the color pattern illustrated in FIG. 18.

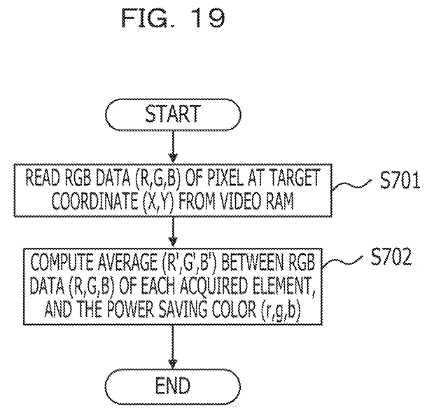

As illustrated in FIG. 19, when computing an average value, the compensation unit 34 first reads out the RGB data for the pixel set as the computation target from the video RAM 15A (S701). The compensation unit 34 then computes the average values between the RGB data for the individual pixel that was read out, and the RGB data (i.e., color information) expressed by the power saving color (S702).

If (R,G,B) is taken to be the RGB data for the target pixel, and (r,g,b) is taken to be the color information expressed by the power saving color, then their average value (R′,G′,B′) can be computed using the following formulas:

R′=(R+r)/2

G′=(G+g)/2

B′=(B+b)/2

Herein, the remainders of the division operations may be rounded up or rounded down, so long as one method is consistently used.

By way of example, assume that the RGB data for the target pixel expresses yellow (R=255, G=255, B=0). In the present embodiment, the power saving color is white (R=255, G=255, B=255). Consequently, the RGB data for the target pixel that is written to the video RAM 15A becomes (R=255, G=255, B=128). This RGB data expresses a bright yellow. Herein, the remainder of the division operation is set to be rounded up.

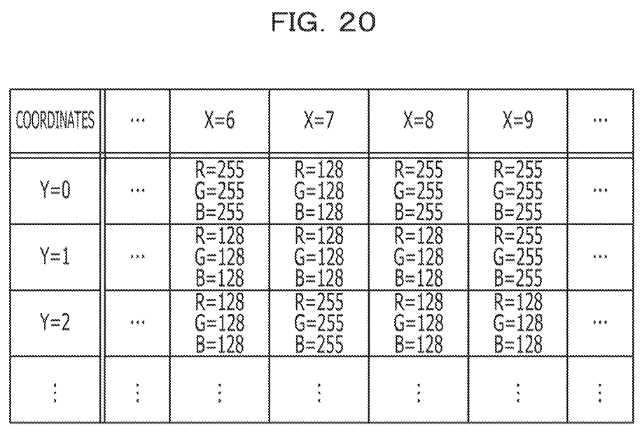

As indicated in the above process, an average value is computed between a pixel's RGB data and the power saving color. As illustrated in FIG. 20, such a process can be utilized to overwrite the data array in the video RAM 15A illustrated in FIG. 17 described above. In so doing, colors close to the power saving color are displayed.

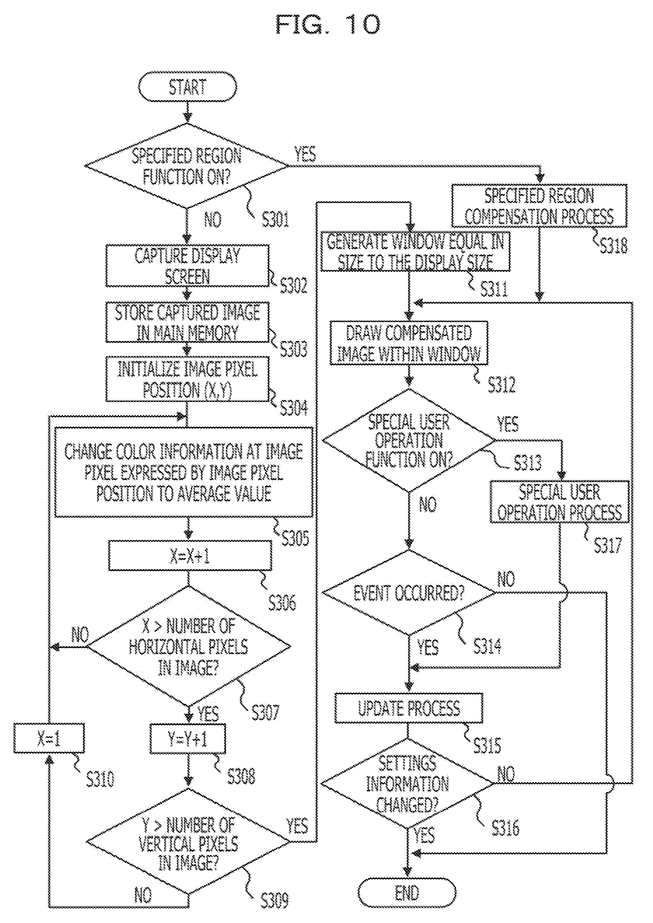

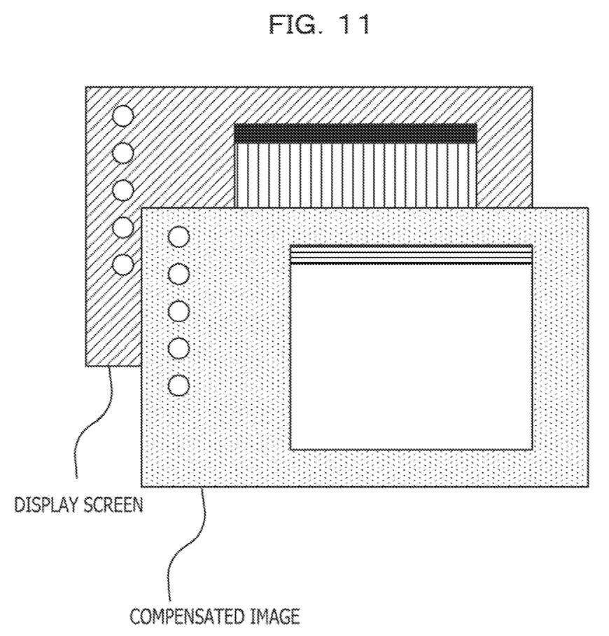

Next, the operation of the screen compensation process will be described. FIG. 10 is a flowchart illustrating the operation of an example screen compensation process. FIG. 11 illustrates a display screen and its compensated image.

As illustrated in FIG. 10, the settings determining unit 31 determines whether or not the specified region function is ON (S301).

If the specified region function is OFF (S301, NO), then the image acquisition unit 33 captures the display screen (S302), and stores the captured image in the main memory (S303). Next, the compensation unit 34 initializes the target image pixel position (X,Y) where image processing is to be conducted with respect to the image stored in the main memory 12 (S304). Herein, X is a variable expressing the horizontal position, and Y is a variable expressing the vertical position. These variables are both set to 1.

Next, the compensation unit 34 computes the average value between the color value of the image pixel expressed by the image pixel position, and the power saving color. The compensation unit 34 then changes the color value at the image pixel position to the computed average value (S305). After changing the value, the compensation unit 34 increments X by 1 (S306), and determines whether or not the value of X is greater than the number of image pixels in the horizontal direction of the image (S307). Herein, the process described earlier with reference to FIG. 19 can be applied as the process for computing the average value between the color value of the image pixel and the power saving color.

If the value of X is greater than the number of image pixels in the horizontal direction of the image (S307, YES), then the compensation unit 34 increments Y by 1 (S308), and determines whether or not the value of the Y is greater than the number of image pixels in the vertical direction of the image (S309).

If the value of Y is less than or equal to the number of image pixels in the vertical direction of the image (S309, NO), then the compensation unit 34 substitutes 1 for the value of X (S310). The compensation unit 34 computes the average value between the color value of the image pixel expressed by the image pixel position, and the power saving color. The compensation unit 34 then changes the color value at the image pixel position to the computed average value (S305).

Meanwhile, if it is determined in step S307 that the value of X is less than or equal to the number of image pixels in the horizontal direction of the image (S307, NO), then the compensation unit 34 computes the average value between the color value of the image pixel expressed by the image pixel position, and the power saving color. The compensation unit 34 then changes the color value at the image pixel position to the computed average value (S305).

Meanwhile, if it is determined in step S309 that the value of Y is greater than the number of image pixels in the vertical direction of the image (S309, YES), then the display unit 37 generates a window on the desktop that is equal in size to the display size (S311). Next, as illustrated in FIG. 11, the display unit 37 draws the compensated image in the main memory 12 within the window (S312). Next, the settings determining unit 31 determines whether or not the special user operation function is ON (S313).

If the special user operation function is ON (S313, NO), then the compensation unit 34 determines whether or not an event related to screen display has occurred in the OS 171 (S314). At this point, the compensation unit 34 monitors the event handler of the OS 171, and when the event handler is an event handler related to screen display, the compensation unit 34 determines that an event related to screen display has occurred.

If an event related to screen display has occurred (S314, YES), then the image control apparatus 1 executes an update process to be hereinafter described (S315), and the settings determining unit 31 determines whether or not the settings information has changed (S316).

If the settings information has changed (S316, YES), then the settings determining unit 31 terminates the screen compensation process.

In contrast, if the settings information has not changed (S316, NO), then the display unit 37 draws the compensated image within the window (S312).

Meanwhile, if it is determined in step S314 that an event related to screen display has not occurred (S314, NO), then the compensation unit 34 terminates the screen compensation process.

If it is determined in step S313 that the special user operation function is ON (S313, YES), then the image control apparatus 1 executes a special user operation process to be hereinafter describe (S317).

If it is determined in step S301 that the specified region function is ON (S301, YES), then the image control apparatus 1 executes a specified region compensation process to be hereinafter described (S318). Next, the display unit 37 draws the compensated image within the window (S312).

In this way, by compensating the entire display screen on the basis of the power saving color, the display colors of desktop elements such as icons and windows are compensated for in addition to the wallpaper. For this reason, increased power saving effects may be exhibited, as compared to the case of using a power saving wallpaper.

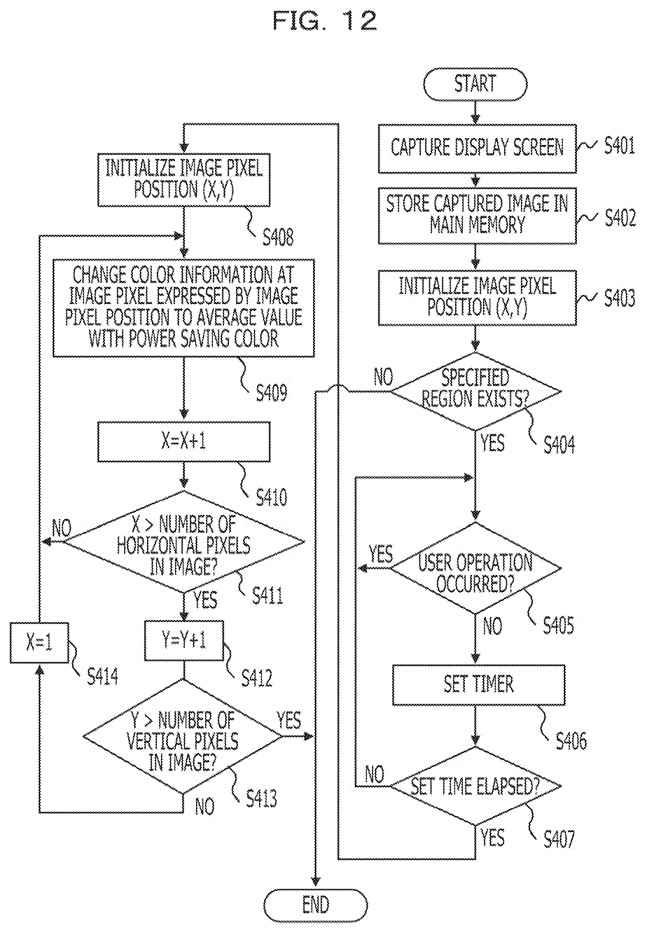

The operation of the specified region compensation process will now be described. FIG. 12 is a flowchart illustrating a specified region compensation process.

As illustrated in FIG. 12, first the image acquisition unit 33 captures the display screen (S401), and stores the captured image in the main memory (S402). Next, the compensation unit 34 initializes the target image pixel position (X,Y) where image processing is to be conducted with respect to the image stored in the main memory 12 (S403). Herein, X is a variable expressing the horizontal position, and Y is a variable expressing the vertical position. These variables are both set to 1.

Next, the compensation unit 34 determines whether or not there exists a specified region on the display screen that has been specified in the settings information (S404).

If a specified region does exist (S404, YES), then the compensation unit 34 determines whether or not the user has performed an operation with the mouse 19 (S405). Herein, the compensation unit 34 makes a determination by monitoring event handlers related to input with respect to the OS 171.

If a user operation has not occurred (S405, NO), then the compensation unit 34 sets a timer of a specified duration (S406), and determines whether or not the specified time duration has elapsed since the timer was set (S407).

If the specified time duration (amount of time) has elapsed since the timer was set (S407, YES), then the compensation unit 34 next initializes the target image pixel position (X,Y) where image processing is to be conducted with respect to the image stored in the main memory 12 (S408). Herein, X is a variable expressing the horizontal position of the specified region expressed by a rectangle, and Y is a variable expressing the vertical position of the specified region. When initialized, X is set to the image pixel position at the left edge of the specified region, and Y is set to the image pixel position at the top edge of the specified region.

Next, the compensation unit 34 computes the average value between the color value of the image pixel expressed by the image pixel position, and the power saving color. The compensation unit 34 then changes the color value at the image pixel position to the computed average value (S409). After changing the value, the compensation unit 34 increments X by 1 (S410), and determines whether or not the value of X is greater than the number of image pixels in the horizontal direction of the image (S411). Herein, the process described earlier with reference to FIG. 19 can be applied as the process for computing the average value between the color value of the image pixel and the power saving color.

If the value of X is greater than the number of image pixels in the horizontal direction of the image (S411, YES), then the compensation unit 34 increments Y by 1 (S412), and determines whether or not the value of the Y is greater than the number of image pixels in the vertical direction of the image (S413).

If the value of Y is less than or equal to the number of image pixels in the vertical direction of the image (S413, NO), then the compensation unit 34 substitutes 1 for the value of X (S464). The compensation unit 34 computes the average value between the color value of the image pixel expressed by the image pixel position, and the power saving color. The compensation unit 34 then changes the color value at the image pixel position to the computed average value (S406).

Meanwhile, if it is determined in step S411 that the value of X is less than or equal to the number of image pixels in the horizontal direction of the image (S411, NO), then the compensation unit 34 computes the average value between the color value of the image pixel expressed by the image pixel position, and the power saving color. The compensation unit 34 then changes the color value at the image pixel position to the computed average value (S409).

Meanwhile, if it is determined in step S413 that the value of Y is greater than the number of image pixels in the vertical direction of the image (S413, YES), then the compensation unit 34 terminates the specified region compensation process.

Meanwhile, if it is determined in step S407 that the time duration has not elapsed (S407, NO), then the compensation unit 34 determines whether or not the user has performed an operation with the mouse 19 (S405).

If it is determined in step S405 that the user has performed an operation with the mouse 19 (S405, YES), then the compensation unit 34 once again determines whether or not the user has performed an operation with the mouse 19 (S405).

In this way, by compensating only a specified region within the display screen on the basis of the power saving color, power consumption by the display device 14 can be decreased, while also maintaining the visibility of screen portions other than the specified region.

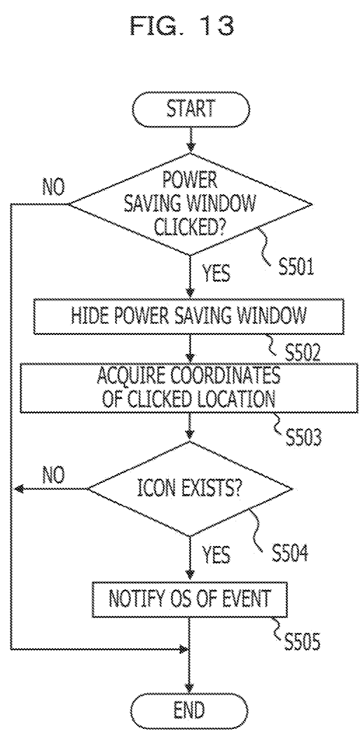

The operation of the special user operation process will now be described. FIG. 13 is a flowchart illustrating a special user operation process.

As illustrated in FIG. 13, once triggered by a set process, the operation acquisition unit 38 determines whether or not the power saving window has been clicked (S501). Herein, the power saving window is a window in which an image compensated by the power saving color has been drawn.

If the power saving window has been clicked (S501, YES), the processor 39 executes a process that has been set in response to a click. In this case, the processor 39 hides the power saving window (S502). Next, the operation acquisition unit 38 acquires the coordinates of the clicked location (S503), and determines whether or not an icon exists at the acquired coordinates (S504).

If an icon does exist at the acquired coordinates (S504, YES), then the processor 39 notifies the OS 171 of the operation event (S505), and then terminates the special user operation process.

Meanwhile, if an icon does not exist at the acquired coordinates (S504, NO), then the processor 39 terminates the special user operation process.

If it is determined in step S501 that the power saving window has not been clicked (S501, NO), then the operation acquisition unit 38 terminates the special user operation process.

In this way, by executing a particular process set with respect to a user operation performed on the power saving window, the display processing of the OS 171 can be expanded. For example, the process executed in response to a user operation on the power saving window may be a process for enlarging the clicked area, or a process for displaying an original menu.

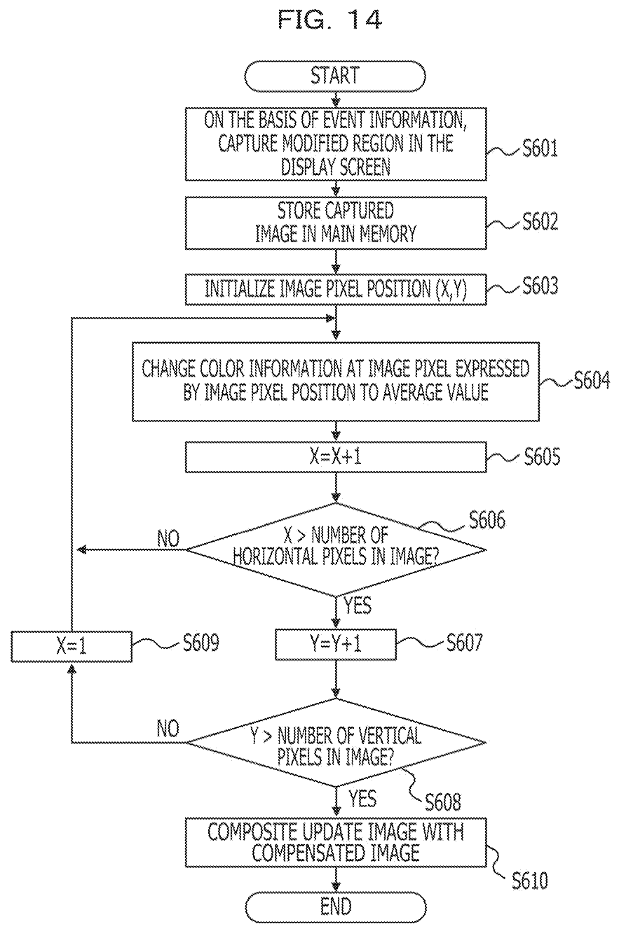

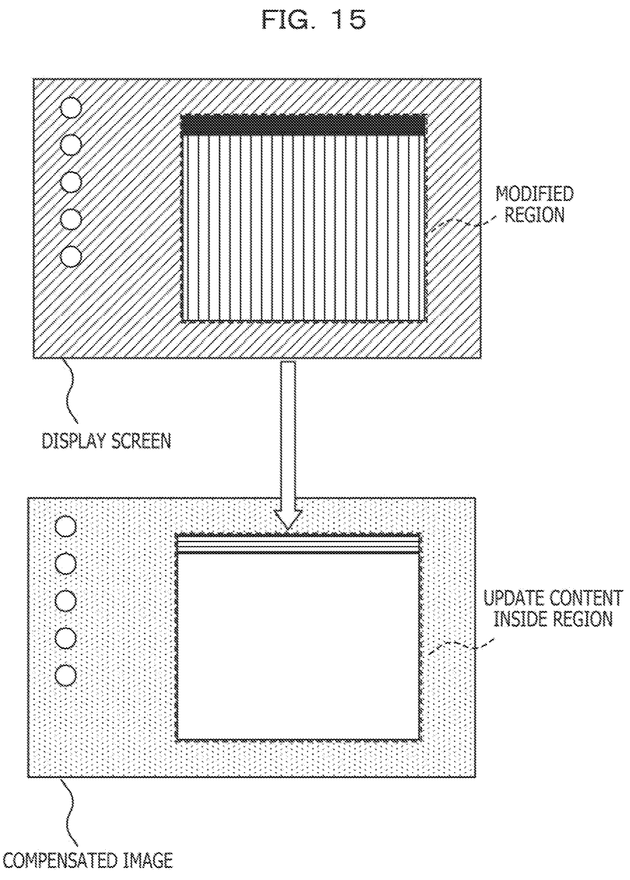

The operation of the update process will now be described. FIG. 14 is a flowchart illustrating an update process. FIG. 15 illustrates an update conducted by the update process.

As illustrated in FIG. 14, first the compensation unit 34 specifies and captures a modified region of the display screen (S601), and stores the captured image in the main memory as an update image (S602). At this point, the compensation unit 34 specifies and captures the modified region on the basis of information about an event that has occurred. Next, the compensation unit 34 initializes the target image pixel position (X,Y) where image processing is to be conducted with respect to the update image stored in the main memory 12 (S603). Herein, X is a variable expressing the horizontal position, and Y is a variable expressing the vertical position. These variables are both set to 1.

Next, the compensation unit 34 computes the average value between the color value of the image pixel expressed by the image pixel position, and the power saving color. The compensation unit 34 then changes the color value at the image pixel position to the computed average value (S604). After changing the value, the compensation unit 34 increments X by 1 (S605), and determines whether or not the value of X is greater than the number of image pixels in the horizontal direction of the image (S606). Herein, the process described earlier with reference to FIG. 19 can be applied as the process for computing the average value between the color value of the image pixel and the power saving color.

If the value of X is greater than the number of image pixels in the horizontal direction of the image (S606, YES), then the compensation unit 34 increments Y by 1 (S607), and determines whether or not the value of the Y is greater than the number of image pixels in the vertical direction of the image (S608).

If the value of Y is less than or equal to the number of image pixels in the vertical direction of the image (S608, NO), then the compensation unit 34 substitutes 1 for the value of X (S609). The compensation unit 34 computes the average value between the color value of the image pixel expressed by the image pixel position, and the power saving color. The compensation unit 34 then changes the color value at the image pixel position to the computed average value (S604).

Meanwhile, if it is determined in step S606 that the value of X is less than or equal to the number of image pixels in the horizontal direction of the image (S606, NO), then the compensation unit 34 computes the average value between the color value of the image pixel expressed by the image pixel position and the power saving color. The compensation unit 34 then changes the color value at the image pixel position to the computed average value (S604).

Meanwhile, if it is determined in step S608 that the value of Y is greater than the number of image pixels in the vertical direction of the image (S608, YES), then the compensation unit 34 composites the update image with the compensated image (S610). More specifically, the update image is inserted into the compensated image at a location corresponding to the modified region of the display screen.

In this way, as a result of the update process, only areas with changes in their display are updated. For example, as illustrated in FIG. 15, if a window is opened on the desktop, only that window is captured, and an update image obtained by compensating this captured image is then composited with the compensated image. By such a process, the processing load involved in updating the compensated image can be reduced.

The video RAM 15A of the graphics controller 15 may also store the RGB data for a plurality of screens. In this case, the video RAM 15A may store a single screen of pre-compensation RGB arrayed in a table, as well as a single screen of post-compensation RGB data arrayed in a table. The compensated image may then be displayed by switching out these tables.

It should be appreciated that the technology described above is applicable to all devices that display information on a display device, such as mobile phones and personal computers (i.e., information processing apparatus), for example. Herein, a display device refers to a type of display apparatus that displays information by applying voltages to display pixels, for example. The personal computer herein may be a desktop computer, a laptop computer, or a palmtop computer, for example.

An image control program may also be provided, in the form of a program that causes the respective processing steps described earlier to be executed on a computer system that includes an image control apparatus 1 like that described earlier. By storing such a program onto a non-transitory, recording medium that is readable by the computer system, the program may be executed on a computer system, thereby by causing a portion of the computer system to operate as the image control apparatus 1. The program that executes the respective processing steps described earlier may be stored on a portable recording medium such as the disk 221 illustrated in FIG. 1. In addition, an image control program (i.e., image control software) that at least equips a computer system with image control functions may be input into a computer system and compiled. Such a program causes the computer system to operate as an image control apparatus having image control functions. Furthermore, such a program may be stored onto a recording medium that is readable by the computer system, such as the disk 221, for example. Herein, the recording medium that is readable by the computer system may be: ROM, RAM, or a similar internal memory apparatus installed inside the computer; a portable recording medium such as the disk 221, a flexible disk, a DVD disc, a magneto-optical disc, or an IC card (i.e., smart card); or a database that stores computer programs. Alternatively, the recording medium may be another computer system and its database, or any of various types of recording media accessible by a computer system.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An image control apparatus, comprising:
a color information acquisition unit configured to acquire, from a memory, color information expressing a power saving color;
a display image acquisition unit configured to acquire a display image displayed on a display device;
a compensation unit configured to compensate the display image acquired by the display image acquisition unit, based on the acquired color information; and
a display unit configured to cause the display device to display the compensated display image.

2. The image control apparatus according to claim 1,
wherein the display image is a background image set in a graphical user interface presented by an operating system and displayed by the display device.

3. The image control apparatus according to claim 1,
wherein the display image is a captured image of the display screen displayed by the display device.

4. The image control apparatus according to claim 3,
wherein the display device displays a graphical user interface presented by an operating system, and the display unit generates a window in the graphical user interface, and draws the display image compensated by the compensation unit within the window.

5. The image control apparatus according to claim 4, further comprising:
an operation event acquisition unit configured to acquire an operation event performed with respect to the window generated by the display unit; and
a display processing unit configured to execute display processing with respect to the operation event acquired by the operation event acquisition unit.

6. The image control apparatus according to claim 1,
wherein the compensation unit compensates the display image by computing averages between the display color expressed by the color information and the colors of respective pixels in the display image.

7. The image control apparatus according to claim 1,
wherein the display image displayed by the display device is a user-selected image.

8. An information processing apparatus, comprising:
a display device; and
an image control apparatus including;
a color information acquisition unit configured to acquire, from a memory, color information expressing a power saving color, the power saving color being a display color whereby the power consumption is minimized for the screen display produced by the display device,
a display image acquisition unit configured to acquire a display image displayed on the display device,
a compensation unit configured to compensate the display image acquired by display image acquisition unit, based on the acquired color information, and
a display unit configured to cause the display device to display the compensated display image.

9. A computer-readable recording medium storing an image control program executed on a computer, the image control program causing the computer to executed:
acquiring, from a memory, color information expressing a power saving color, the power saving color being a display color whereby the power consumption is minimized for a screen display produced by a display device;
acquiring a display image displayed on the display device;
compensating the acquired display image based on the acquired color information; and
displaying the compensated display image on the display device.

10. The recording medium according to claim 9,
wherein the display image is a background image set in a graphical user interface presented by an operating system and displayed by the display device.

11. The recording medium according to claim 9,
wherein the display image is a captured image of the display screen displayed by the display device.

12. The recording medium according to claim 11,
wherein the display device displays a graphical user interface presented by an operating system, and
the compensated display image is displayed by generating a window in the graphical user interface, and drawing the compensated display image within the generated window.

13. The recording medium according to claim 12,
wherein the image control program causes the computer to additionally execute:
acquiring an operation event performed with respect to the generated window; and
executing display processing with respect to the acquired operation event.

14. The recording medium according to claim 9,
wherein the compensating the display image includes computing averages between the display color expressed by the color information and the colors of respective pixels in the display image.

15. An image control method, comprising:
acquiring, from a memory, color information expressing a power saving color, the power saving color being a display color whereby the power consumption is minimized for a screen display produced by a display device;
acquiring a display image displayed on the display device;
compensating the acquired display image based on the acquired color information; and
displaying the compensated display image on the display device.

16. The image control method according to claim 15,
wherein the display image is a background image set in a graphical user interface presented by an operating system and displayed by the display device.

17. The image control method according to claim 15,
wherein the display image is a captured image of the display screen displayed by the display device.

18. The image control method according to claim 17,
wherein the display device displays a graphical user interface presented by an operating system, and
the compensated display image is displayed by generating a window in the graphical user interface, and drawing the compensated display image within the generated window.

19. The image control method according to claim 18, further comprising:
acquiring an operation event performed with respect to the generated window; and
executing display processing with respect to the acquired operation event.

20. The image control method according to claim 15,
wherein the compensating the display image includes computing the averages between the display color expressed by the color information and the colors of respective pixels in the display image.
